(19) United States
(12) Patent Application Publication
(10) Pub. No.: US 2022/0343144 A1
(43) Pub. Date: Oct. 27, 2022

(54) SERVER AND ACCELERATOR FOR NEURAL NETWORK COMPUTATIONS

(71) Applicant: Alibaba (China) Co., Ltd., Hangzhou (CN)

(72) Inventors: Ling LIANG, Beijing (CN); Yijin GUAN, Beijing (CN); Fei SUN, San Jose, CA (US)

(21) Appl. No.: 17/717,111

(22) Filed: Apr. 10, 2022

(30) Foreign Application Priority Data
Apr. 21, 2021 (CN) 202110429439.6

(51) Int. Cl. G06N 3/04; G06F 9/50; H04L 67/10

(52) U.S. Cl. CPC G06N 3/0481; G06F 9/5027; H04L 67/10

(57) ABSTRACT

Disclosed are an acceleration unit for executing a neural network model and a server. The acceleration unit includes: a plurality of cluster groups, where each of the cluster groups includes a plurality of processing clusters; an on-chip memory, including a plurality of storage units, where each storage unit corresponds to each of the cluster groups, and is configured to store an instruction sequence and operation data of the corresponding cluster group; a command processor, configured to decompose an operation associated with a specified neural network model into a plurality of sub-operations, convert the plurality of sub-operations into a plurality of instruction sequences, specify operation data of each of the instruction sequences; and a plurality of distribution units, where each distribution unit reads the instruction sequence and operation data of the instruction sequence from the corresponding storage unit into the corresponding cluster group.

### CROSS REFERENCE TO RELATED APPLICATIONS

This application claims priority to Chinese Patent Application No. 202110429439.6, filed on Apr. 21, 2021. The entire contents of the above-identified application are incorporated herein by reference.

### TECHNICAL FIELD

The present disclosure relates to the field of neural networks, and in particular, to an acceleration unit for executing a neural network model and a server.

### BACKGROUND

Neural networks (NNs) are one of the most popular technologies that have been emerging again in the recent decade. Neural networks have made many breakthrough advances in the fields of voice, image, big data, and biomedical science and technology, and have implemented many applications. In addition, the industry also pays more attention to execution efficiency improvement of a neural network model, which mainly includes two measures: in a software aspect, performance is improved by using algorithm optimization of the neural network model; and in a hardware aspect, performance improvement is implemented by designing various hardware acceleration units used to execute the neural network model.

### SUMMARY

An objective of the present disclosure is to provide an acceleration unit, a hardware accelerator, and a server for accelerating the execution of a neural network model.

According to a first aspect of embodiments of the present disclosure, a hardware accelerator for accelerating the execution of a neural network model is provided, including: a direct memory access module, configured to load operation data of a plurality of sub-operations for a plurality of times; a plurality of cluster groups, wherein each of the cluster groups comprises a plurality of processing clusters; an on-chip memory, comprising a plurality of storage units that are respectively corresponding to the plurality of cluster groups, and each of the plurality of storage units is configured to store an instruction sequence and operation data for the corresponding cluster group; a command processor, configured to decompose an operation associated with a specified neural network model into a plurality of sub-operations, convert the plurality of sub-operations into a plurality of instruction sequences executable on the plurality of processing clusters, and specify operation data for execution of each of the instruction sequences; and a plurality of distribution units, respectively coupled to the plurality of storage units, and respectively coupled to the plurality of cluster groups, wherein each distribution unit is configured to read the instruction sequence and operation data of the instruction sequence from the storage unit coupled to the distribution unit, and sends the instruction sequence and the operation data of the instruction sequence to the cluster group coupled to the distribution unit.

In some embodiments, each of the distribution units is coupled to the plurality of processing clusters in the corresponding cluster group by using a first bus, each distribution unit sends the instruction sequence and operation data of the instruction sequence to the first bus, and the plurality of processing clusters coupled to the distribution unit obtains the instruction sequence and the operation data of the instruction sequence from the first bus.

In some embodiments, the processing cluster includes a cluster control unit and a plurality of execution units that are coupled to the cluster control unit by using a second bus and that have the same function, the cluster control unit obtains the instruction sequence and controls the plurality of execution units coupled to the cluster control unit to separately execute the instruction sequence, and the plurality of execution units coupled to the cluster control unit load operation data required by the plurality of execution units from the second bus when executing a data loading instruction.

In some embodiments, the decomposing an operation associated with a specified neural network model into a plurality of sub-operations includes: converting a high-dimensional matrix operation of weight data and activation data into a plurality of two-dimensional matrix operations; and the converting the plurality of sub-operations into a plurality of instruction sequences executable on the processing cluster includes: converting the plurality of two-dimensional matrix operations into a plurality of instruction sequences executable on the processing cluster.

In some embodiments, the converting a high-dimensional matrix operation of weight data and activation data into a plurality of two-dimensional matrix operations further includes: when a size of a two-dimensional matrix exceeds a preset standard, dividing the two-dimensional matrix by rows and/or columns into a plurality of sub-matrices, and converting the plurality of two-dimensional matrix operations into matrix operations based on the plurality of sub-matrices.

In some embodiments, the converting the high-dimensional matrix operation of weight data and activation data into the plurality of two-dimensional matrix operations comprises: converting four-dimensional activation data into a two-dimensional activation data by mapping three dimensions of the four-dimensional activation data into one dimension of the two-dimensional activation data; and converting four-dimensional weight data into a two-dimensional weight data by mapping three dimensions of the four-dimensional weight data into one dimension of the two-dimensional weight data.

In some embodiments, the command processor configures a plurality of mapping methods to convert the high-dimensional matrix operation of the weight data and the activation data into a plurality of two-dimensional matrix operations, wherein the high-dimensional matrix operation comprises operating a plurality of three-or-more-dimension matrices.

In some embodiments, the command processor configures a preferred mapping method for a specific operation associated with the specified neural network model, for the command processor to use the configured preferred mapping method for the specific operation.

In some embodiments, the operation associated with the specified neural network model is one of matrix multiplication, convolution, and depth convolution.

In some embodiments, the preferred mapping method comprises keeping activation data in the processing cluster longer than weight data during the plurality of two-dimensional matrix operations.

In some embodiments, the preferred mapping method comprises keeping weight data in the processing cluster longer than activation data during the plurality of two-dimensional matrix operations.

In some embodiments, the command processor is further configured to: receive indication information, and determine, according to the indication information, the operation associated with the specified neural network model and a storage location of operation data of the operation.

In some embodiments, the distribution unit is further configured to: store intermediate result data of a processing cluster coupled to the distribution unit into a corresponding storage unit, and store the intermediate result data into an external memory by using the direct memory access module.

In some embodiments, the weight data is represented as a combination of an index and a non-zero value.

In some embodiments, before the execution unit loads the weight data, the command processor or the distribution unit represents the weight data as a combination of an index and a non-zero value.

In some embodiments, the command processor further includes: converting a special function in the neural network model into a special instruction that can be executed on the execution unit.

According to a second aspect, an embodiment of the present disclosure provides a server, including:
the acceleration unit according to any one of the foregoing items;
a scheduler, configured to instruct the acceleration unit to perform the operation associated with a specified neural network model; and
a memory, configured to store weight data and activation data of the specified neural network application.

In some embodiments, each of the plurality of storage unit comprises a first buffer unit and a second buffer unit, the first buffer unit is configured to load data from an external memory while the second buffer unit is configured to feed data stored therein into the corresponding cluster group.

In some embodiments, the first buffer unit and the second buffer unit switch roles after each iteration of processing in the corresponding cluster group.

The acceleration unit provided in the embodiments of the present disclosure includes a plurality of cluster groups, and each cluster group includes a plurality of processing clusters. The acceleration unit decomposes an operation associated with a specified neural network model into a plurality of sub-operations, converts each sub-operation into an instruction sequence executed on the processing cluster, and specifies operation data of each instruction sequence, so as to perform each sub-operation in parallel by using the plurality of cluster groups, thereby implementing performance improvement of the hardware acceleration unit.

### BRIEF DESCRIPTION OF THE DRAWINGS

The foregoing and other objectives, features, and advantages of the present disclosure are becoming more obvious through the descriptions of the embodiments of the present disclosure with reference to the following accompanying drawings. In the accompanying drawings:

FIG. 1 illustrates a hierarchical structure diagram of a data center in accordance with some embodiments.

FIG. 2 illustrates a 3D structural diagram of a data center in accordance with some embodiments.

FIG. 3 illustrates a schematic structural diagram of a common structure cloud server in a data center in accordance with some embodiments.

FIG. 4 illustrates a specific schematic structural diagram of the cloud server in FIG. 3 in accordance with some embodiments.

FIG. 5 illustrates a design diagram of an example PE cluster in accordance with some embodiments.

FIG. 6a illustrates a schematic diagram of matrix multiplication in accordance with some embodiments.

FIGS. 6b and FIG. 6c illustrate schematic diagrams of convolution and depth convolution in accordance with some embodiments.

FIG. 7a to FIG. 7c illustrate three segments of pseudo code in accordance with some embodiments.

FIG. 8 illustrates a schematic diagram of an example two-dimensional matrix multiplication in accordance with some embodiments.

FIG. 9a to FIG. 9i are used to show different embodiments of deploying the matrix multiplication shown in FIG. 8 to a PE array.

### DETAILED DESCRIPTION

The following describes the present disclosure based on the embodiments, but the present disclosure is not merely limited to the embodiments. Some specified details are described in the following detailed descriptions of the present disclosure. A person skilled in the art may also fully understand the present disclosure without the descriptions of the details. To prevent the essence of the present disclosure from being confused, well-known methods, procedures, and processes are not described in detail. In addition, the accompanying drawings are not necessarily drawn to scale.

The following terms are used herein.

Acceleration unit or hardware accelerator: For cases where general purpose processors are inefficient for special purposes or fields (for example, processing images, processing neural network operations, etc.), acceleration units are processing units or hardware devices designed to increase the data processing speed for special purposes or fields. The acceleration units are often used in conjunction with the general purpose processors CPUs, accept control of the general purpose processors, perform processing for specific purposes or fields, and improve computer processing efficiency for specific purposes or fields. Acceleration units may also be referred to as AI processing units, and may include a graphics processing unit (GPU), a central processing unit (CPU), an application-specific integrated circuit (ASIC), a field programmable gate array (FPGA), an application-specific integrated circuit (ASIC), and dedicated AI acceleration hardware (such as an acceleration unit).

On-chip memory: On-chip memory refers to a memory that is used separately in a primary core or a secondary core and cannot be shared.

Command processor: Command processor refers to command interface between an acceleration unit and a central processing unit that drives the acceleration unit to work. The command processor receives instructions the central processing unit requests the acceleration unit to execute, and divides the instructions into components in the acceleration unit to execute. In addition, the command processor is further responsible for synchronization of the components in the acceleration unit.

Lifecycle: An operand is not involved in all processes of an instruction sequence. A part between the first occurrence of the operand and the last time the operand is used in the instruction sequence is a lifecycle of the operand. That is, after the lifecycle expires, the operand is no longer used, and does not need to stay in an on-chip memory.

Neural network: In some embodiments, neural network refers to an artificial neural network (ANN), and is an algorithm network that imitates a behavior feature of an animal neural network and performs distributed parallel information processing. A classical neural network is also the simplest neural network structure, and includes three layers: an input layer, an output layer, and an intermediate layer (also referred to as a hidden layer). The input layer, the output layer, and the intermediate layer each include a plurality of nodes.

Neural network model: In a neural network, nodes are mathematically represented, and mathematical models of the nodes are generated. Mathematical models of a large quantity of nodes in the neural network form a neural network model.

Deep learning model: The concept of deep learning is derived from the study of neural networks. A neural network that contains a plurality of intermediate layers is referred to as a deep learning network. Therefore, in this sense, the deep learning model is also a neural network model. Both the deep learning model and the neural network model need to be generated through training. Sample data is input into a designed network structure, feature information is extracted by using a plurality of intermediate layers, and weight data of each node is constantly corrected based on an output result of an output layer, so that the output result of the output layer gradually approximates a preset result, until final weight data is determined. The trained deep learning model may be truly applied to an actual scenario, and use of the deep learning model in the actual scenario may be collected, to optimize in turn the deep learning model.

Node: A node is a minimum unit of an independent operation in a deep learning model, receives an input, and generates an output after an operation using a weight parameter of the node or a parameter (for example, a hyperparameter) in another model. The deep learning model may include various specific operations such as convolution and pooling, and further includes various operation nodes such as a convolution node and a pooling node. The deep learning model has a plurality of layers, each layer has a plurality of nodes, and an output of each node is an input to a node of a next layer. Further, the node includes a program for a specific operation and related data. For example, the convolution operation node includes program code used for the convolution operation and some data used for convolution.

Operator: An operator is a set of operations constructed in a deep learning model to implement a specific function. Each layer of the deep learning model may include a plurality of such operators. The operator may be referred to as an operation in the TensorFlow framework and a layer in the Caffe framework. The operator is considered as a further implementation based on a node, and one operator may correspond to one or more nodes. Therefore, programs and data corresponding to the operator and the node are sometimes the same.

Instruction set: An instruction set is a set of instructions that are supported by a chip to perform an operation, for example, an operation that mainly supports a deep learning operator, for example, Convolution, Pooling, ROI, etc.

Neural network application: A neural network application refers to an operation such as a matrix operation, convolution, and depth convolution in a neural network model. An operation or a specific operation associated with a neural network application and the neural network application have the same meaning below.

Data Center

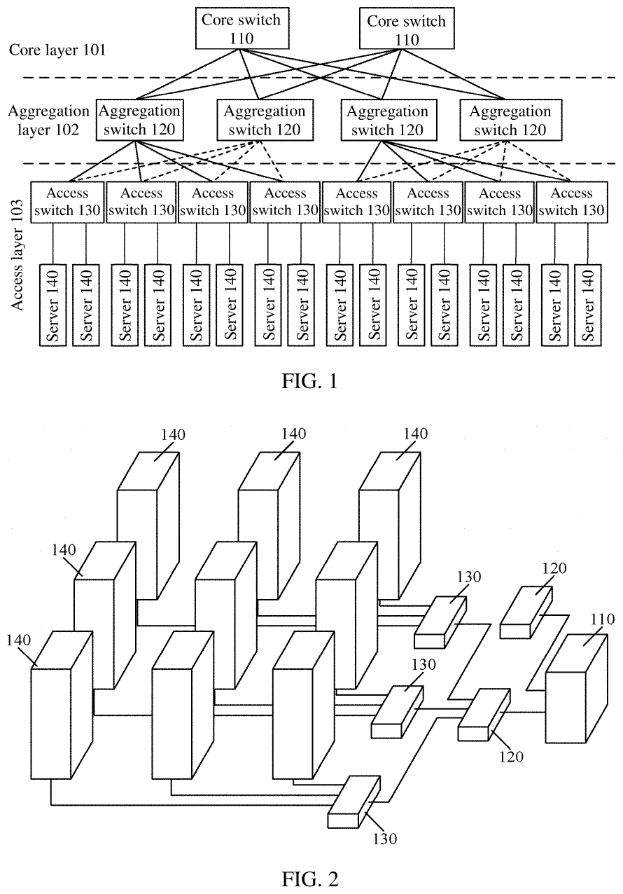

FIG. 1 illustrates a hierarchical structure diagram of a data center of a scenario to which an embodiment of the present disclosure is applied.

A data center is a globally collaborative specific device network, and is used to transfer, accelerate, display, calculate, and store data information in a network infrastructure of the Internet. Data center are assets for enterprise competition. As data center applications are widespread, artificial intelligence and the like are increasingly applied to data centers. As an important technology of artificial intelligence, neural networks have been widely applied to big data analysis operations of data centers.

In a conventional large data center, a network structure is generally a three-layer structure shown in FIG. 1, that is, a hierarchical inter-networking model. This model includes the following three layers:

An access layer 103 is sometimes referred to as an edge layer, and includes an access switch 130 and servers 140 connected to the access switch. Each server 140 is a processing and storage entity of a data center, and a large quantity of data in the data center is processed and stored by these servers 140. The access switch 130 is configured to allow these servers to access switches in the data center. One access switch 130 accesses a plurality of servers 140. Access switches 130 are usually located at the top of the rack, are also referred to as top of rack switches, and are physically connect to servers.

An aggregation layer 102 is sometimes referred to as a distribution layer and includes an aggregation switch 120. Each aggregation switch 120 is connected to a plurality of access switches and provides other services such as firewall, intrusion detection, and network analysis at the same time.

A core layer 101 includes a core switch 110. The core switch 110 provides high-speed forwarding for packets entering and exiting the data center, and provides connectivity for a plurality of aggregation layers. Networks of the entire data center are divided into an L3 routing network and an L2 routing network. The core switch 110 provides an elastic L3 routing network for the networks of the entire data center.

Generally, the aggregation switch 120 is a demarcation point of the L2 and L3 routing networks, the L2 network is the part below the aggregation switch 120, and the L3 network is the part above the aggregation switch 120. Each group of aggregation switches manages one point of delivery (POD). Each POD has an independent VLAN network therein. The server does not need to modify an IP address and a default gateway when being migrated within the POD because one POD corresponds to one L2 broadcast domain.

A spanning tree protocol (STP) is usually used between the switch 120 and the access switch 130. STP makes one aggregation switch 120 available for one VLAN network, and other aggregation switches 120 are used in the event of a failure (the dashed line in the figure above). That is, there is no horizontal extension at the aggregation layer, because even if a plurality of aggregation switches 120 are added, only one aggregation switch is working at a given point of time.

FIG. 2 illustrates physical connections of components in the hierarchical data center of FIG. 1. As shown in FIG. 2, one core switch 110 is connected to a plurality of aggregation switches 120, one aggregation switch 120 is connected to a plurality of access switches 130, and one access switch 130 accesses a plurality of servers 140.

Cloud Server

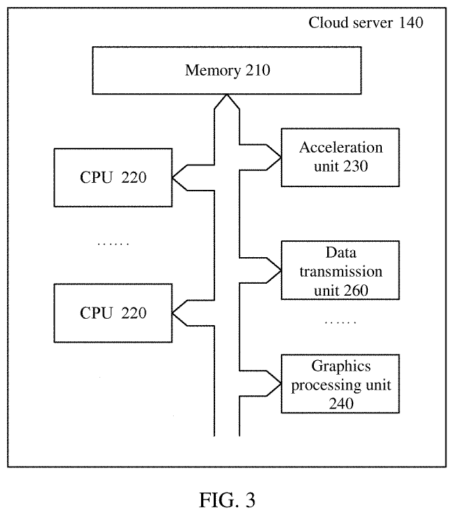

A cloud server 140 is a hardware device of the data center. Because the cloud server 140 operates at a high speed to perform various tasks such as matrix calculation, image processing, machine learning, compression, and search sorting, the cloud server 140 generally includes a central processing unit (CPU) and various acceleration units, as shown in FIG. 3, to efficiently complete the foregoing tasks. The acceleration unit is, for example, one of an acceleration unit dedicated to a neural network, a data transmission unit (DTU), a graphics processing unit (GPU), an application-specific integrated circuit (ASIC), and a field programmable gate array (FPGA). An exemplary acceleration unit is described below, as shown in FIG. 3.

A data transmission unit (DTU) 260 is a wireless terminal device specially configured to convert serial port data into IP data or convert IP data into serial port data for transmission by using a wireless communication network. The main function of the DTU is to send data of a remote device back to a background center wirelessly. At a frontend, the DTU is connected to a device of a customer through an interface. After the DTU is powered on and operates, the DTU registers with a mobile GPRS network, and then establishes a socket connection to a background center in the DTU. The background center serves as a server device of the socket connection, and the DTU is the client of the socket connection. Therefore, the DTU is used together with background software. After the connection is established, the device at the frontend and the center at the background can perform wireless data transmission through the DTU.

A graphics processing unit (GPU) 240 is a processor that specially performs image and graph-related working. Using the GPU overcomes a disadvantage of too small space in a calculation unit in a CPU, and when a large quantity of calculation units dedicated to graphics calculation are used, for a graphics card to reduce dependence on the CPU and undertake some calculation-intensive image processing work originally undertaken by the CPU.

An application-specific integrated circuit (ASIC) is an integrated circuit designed and manufactured to meet specific user requirements and a specific electronic system. Because this type of integrated circuit is customized according to user requirements, a structure of the integrated circuit often corresponds to specific user requirements.

A field programmable gate array (FPGA) is a product developed on the basis of programmable devices such as PAL and GAL. As a semi-customized circuit in the field of application-specific integrated circuit (ASIC), the field programmable gate array not only solves the shortage of customized circuits, but also overcomes the disadvantage of a limited quantity of gate circuits of original programmable devices.

An acceleration unit 230 for a neural network model is a processing unit that uses a data-driven parallel calculation architecture and is configured to process a large quantity of operations (such as convolution and pooling) of each neural network node. Because data in a large quantity of operations (such as convolution and pooling) of each neural network node is closely associated with an intermediate result in an entire calculation process, the acceleration unit is frequently used. When an existing CPU architecture is used, because a memory capacity in a CPU core is very small, a large quantity of out-of-core memory needs to be frequently accessed (e.g., frequent external memory accesses), thereby causing low processing efficiency. When the acceleration unit is used, because the acceleration unit has an on-chip memory provides storage capacity for neural network calculation, frequent access to the out-of-core memory is avoided or reduced, thereby greatly improving processing efficiency and calculation performance.

Although execution efficiency of the acceleration unit 230 is much higher than that of a common processor for a specific application or field, the acceleration unit 230 also needs to be controlled by a processing unit 220. In the following description, an acceleration unit dedicated to a deep learning model is used as an example for illustrative purposes. A memory 210 stores various deep learning models, including neurons of these models, weight data of the neurons, and the like. These deep learning models are deployed to one acceleration unit 230 by one processing unit 220 in FIG. 3 when required. For example, the processing unit 220 may notify, in an instruction form, the acceleration unit 230 of a storage/memory location of the deep learning model of the acceleration unit 230 in the memory 210. The acceleration unit 230 may then perform addressing according to these memory locations, and store a to-be-executed instruction in an on-chip memory of the acceleration unit 230. The processing unit 220 may alternatively send a to-be-executed instruction of the acceleration unit 230 to the acceleration unit 230 in an instruction form, and the acceleration unit 230 receives the instruction and stores the instruction in the on-chip memory. The acceleration unit 230 may further obtain input data in the foregoing manner. Once the acceleration unit 230 obtains the to-be-executed instruction and the input data, inference calculation is performed. Weight data of a node may be included in an instruction sequence of the deep learning model, and taken out from the memory 210 together by the acceleration unit 230. Certainly, the weight data of the node may alternatively be independently stored, and the acceleration unit 230 extracts the weight data from the memory 210 when required. The processing unit 220 is a hardware unit that has a scheduling and control capability, and is generally a hardware unit such as a central processing unit (CPU), a microcontroller, and a microprocessor.

Acceleration Unit in an Embodiment of the Present Disclosure

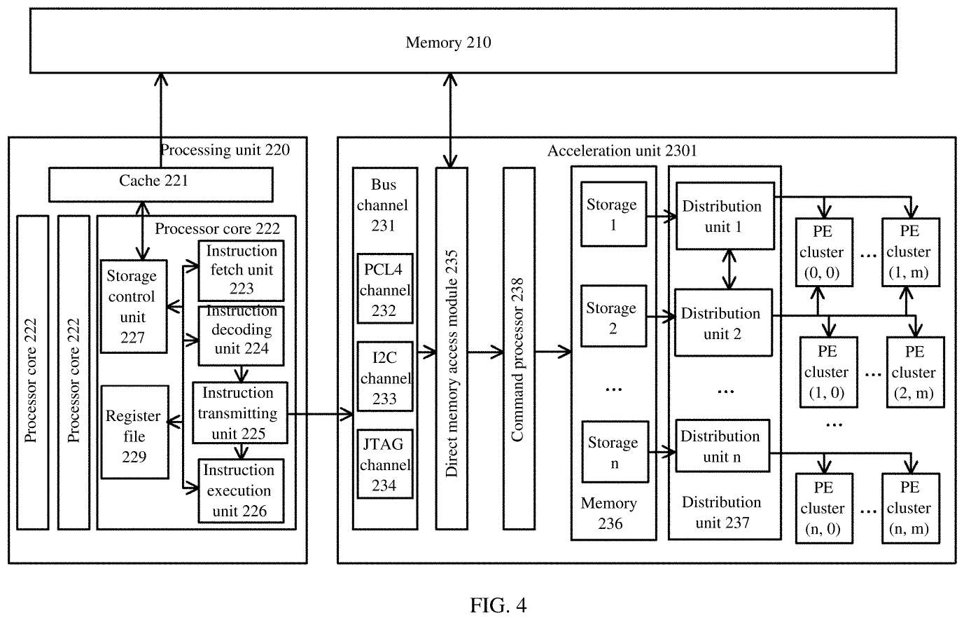

With reference to FIG. 4, the following describes an internal structure of each of the processing unit 220 and an acceleration unit 2301 provided in this embodiment of the present disclosure, and how the processing unit 220 controls the acceleration unit 2301 to work.

As shown in FIG. 4, the processing unit 220 includes a plurality of processor cores 222 and a cache 221 shared by the plurality of processor cores 222. Each processor core 222 includes an instruction fetch unit 203, an instruction decoding unit 224, an instruction transmitting unit 225, and an instruction execution unit 226.

The instruction fetch unit 223 is configured to: transfer a to-be-executed instruction from a memory 210 to an instruction register (which may be a register used to store an instruction in a register file 229 shown in FIG. 4), receive a next instruction fetch address or obtain a next instruction fetch address by means of calculation according to an instruction fetch algorithm, where the instruction fetch algorithm includes, for example, increasing or decreasing an address according to an instruction length.

After an instruction is fetched, the processing unit 220 enters an instruction decoding phase, and the instruction decoding unit 224 decodes the fetched instruction according to a predetermined instruction format, so as to obtain an operand obtaining information required by the fetched instruction, so as to prepare for an operation of the instruction execution unit 225. The operand obtaining information refers to, for example, an immediate, a register, or other software/hardware that can provide a source operand.

The instruction transmitting unit 225 is located between the instruction decoding unit 224 and the instruction execution unit 226, and is configured to schedule and control an instruction, so as to efficiently allocate instructions to different instruction execution units 226 for parallel processing.

After the instruction transmitting unit 225 transmits the instruction to the instruction execution unit 226, the instruction execution unit 226 starts to execute the instruction. However, if the instruction execution unit 226 determines that the instruction should be executed by an acceleration unit, the instruction execution unit 226 forwards the instruction to a corresponding acceleration unit for execution. For example, if the instruction is a neural network inference instruction, the instruction execution unit 226 does not execute the instruction, but sends the instruction to the acceleration unit 2301 by using a bus, and the acceleration unit 2301 executes the instruction.

The acceleration unit 2301 includes a bus channel 231, a direct memory access module 235, an on-chip memory 236, a distribution unit 237, a command processor 238, and an array of processing entities or units (also called a PE array).

The bus channel 231 is a channel for an instruction to enter and exit the acceleration unit 230 from the bus. According to different mechanisms, the bus channel 231 may include a Peripheral Component Interconnect Express (PCIE) channel 232, an I2C channel 233 (alternatively known as IIC, it is a synchronous, multi-controller/multi-target, packet switched, single-ended, serial communication bus), a JTAG channel 234 (JTAG is an industry standard for verifying designs and testing printed circuit boards after manufacture), another suitable channel, or any combination thereof. PCIE, that is, PCI-Express, is a high-speed serial computer extended bus standard, and was proposed in 2001 to replace the old PCI, PCI-X, and AGP bus standards. PCIE supports high-speed serial point-to-point dual-channel high-bandwidth transmission. Connected devices are allocated an exclusive channel bandwidth and do not share a bus bandwidth. PCIE supports functions of active power management, error reporting, end-to-end reliability transmission, hot swap, and quality of service. A main advantage of PCIE is a high data transmission rate, and PCIE also has great development potential. Currently, most PCIE buses are PCIE GEN3. However, in this embodiment of the present disclosure, PCIE GEN4 may also be used, i.e., a bus channel that follows the PCI-Express 4.0 standard. The I2C channel 233 is a simple, two-way two-line synchronous serial bus channel. The I2C channel 233 only needs two lines to transmit information between components connected to a bus. JTAG is short for the Joint Test Action Group and is a common name of IEEE standard 1149.1, Standard Test Access Port and Boundary-Scan Architecture. This standard is used to verify, design, and test functions of manufactured printed circuit boards. In 1990, JTAG was formally standardized by IEEE document 1149.1-1990. In 1994, additional documents were added to describe the boundary scan description language (BSDL). Since then, this standard has been widely adopted by electronic enterprises worldwide. Boundary scan is almost synonymous with JTAG. The JTAG channel 234 is a bus channel that complies with this standard.

The direct memory access (DMA) module 235 is a function provided by some computer bus architectures, and can enable data to be directly written from an additional device (for example, an external memory) to the on-chip memory 236 of the acceleration unit 2301. This manner greatly improves data access efficiency of the acceleration unit 2301 compared with obtaining data by using the processing unit 220. Because of such a mechanism, the acceleration unit 230 may directly access the memory 210 to read a weight of a deep learning model and activation data, thereby greatly improving data access efficiency. Although the figure shows that the direct memory access module 235 is located between the processor 238 and the bus channel 231, the design of the acceleration unit 2301 is not limited thereto. In addition, in some hardware designs, each PE unit may include a direct memory access module 235 to directly read data from an additional device and write the data to the on-chip memory 236.

The command processor 238 receives various instructions from the processing unit 220 by using the bus channel 231, parses the instructions, and drives another component to execute the instructions according to a parsing result. For example, the processing unit 220 instructs the command processor 238 to obtain a to-be-executed instruction of a neural network model and all or a portion of input data of the to-be-executed instruction from a specified address of the memory 210, and the command processor 238 controls the direct memory access module 235 to obtain the to-be-executed instruction and all or a portion of the input data (at least one of a weight and activation data) required by the to-be-executed instruction from the specified address, and then stores the instruction and the data into the on-chip memory 236. In another example, the command processor 238 directly receives, by using the bus channel 231, a to-be-executed instruction of a neural network model, parses the instruction, controls, according to a parsing result, the direct memory access module 235 to obtain, from a specified address, all or a portion of data required for the to-be-executed instruction, and then stores the to-be-executed instruction and the data into the on-chip memory 236.

In the neural network model, neural network applications such as matrix operations, convolution, and depth convolution involve a large quantity of input data, and generally all input data cannot be imported into the acceleration unit 2301 at a time. Therefore, a practice of the acceleration unit 2301 in the embodiments of the present disclosure is as follows: If it is determined that the neural network operation cannot be completed at a time, the command processor 238 divides the to-be-executed neural network operation into a plurality of to-be-executed sub-operations, converts the sub-operations into an instruction sequence (including a plurality of instructions) for execution on PE clusters of a plurality of PE cluster groups, specifies operation data of each instruction sequence, and loads, by using the direct memory access module 235 for a plurality of times, operation data required by each sub-operation, and finally stores, into a corresponding storage unit, an instruction sequence and operation data that are respectively corresponding to a plurality of homogeneous PE clusters included in each PE cluster group. Generally, specifying operation data for each instruction sequence may include evenly assigning operation data of sub-operations to each instruction sequence.

It should be noted that a result generated by each sub-operation is an intermediate result. Therefore, intermediate results of a plurality of sub-operations need to be integrated into a final result. Because the intermediate results are generated in the PE cluster, and storage space on the PE cluster is limited, the intermediate results cannot be stored indefinitely. Therefore, the instruction sequence needs to export back the intermediate result from the PE cluster to a corresponding storage unit or export the intermediate result to the memory 210 by using a corresponding storage unit. In an integration step after all or a portion of sub-operations are completed, there may be a plurality of integration manners, for example, intermediate results of a plurality of PE clusters (PE clusters in the same row in FIG. 4) coupled to the same distribution unit may be integrated, and then intermediate results of a plurality of PE cluster groups are integrated.

As shown in the figure, the command processor 238 is coupled to the memory 236, and the memory 236 is divided into a plurality of storage units. The plurality of storage units are respectively coupled to a plurality of distribution units in a one-to-one correspondence, and each distribution unit is separately coupled to one PE cluster group including a plurality of PE clusters. Each distribution unit obtains, from a storage unit coupled to the distribution unit, an instruction sequence that may be executed on the PE cluster and operation data, and distributes the instruction sequence and the operation data to the PE cluster coupled to the distribution unit. It should be noted that a quantity of PE clusters included in each PE cluster group is the same herein, and a function and a hardware structure of each PE cluster are the same. Therefore, an instruction sequence deployed on the PE cluster to execute may be the same. In some embodiments, the instruction sequence and the operation data of the PE cluster may be sent to the PE cluster for performing a first sub-operation, and in the subsequent sub-operations, only the new operation data is sent to the PE cluster. The instruction sequence will stay in the PE cluster and be reused for the subsequent sub-operations.

In the figure, as an example, there are n storage units and n distribution units, and n rows and m columns of PE clusters. Each distribution unit is coupled to one row of PE clusters by using a first bus. If one row of PE clusters need to obtain the same data, the distribution unit broadcasts the data to the one row of PE clusters by using the first bus. Otherwise, the distribution unit is only responsible for sending, by using the first bus, the instruction sequence and the operation data to each PE cluster coupled to the distribution unit. As shown in the figure, each PE cluster further includes k PE units. Therefore, a three-dimensional PE array with dimensions of n*m*k is formed, where m, n, and k are integers greater than 1.

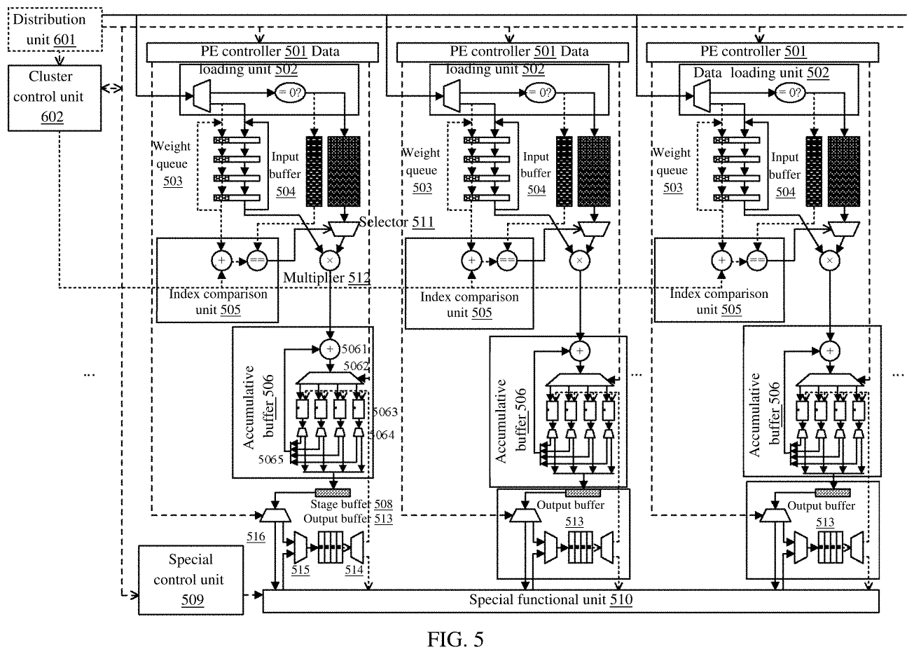

FIG. 5 is a design diagram of an example PE cluster 500. As shown in the figure, a PE cluster 500 includes a cluster control unit 602 and a plurality of PE units that are coupled to the cluster control unit 602 and that are homogeneous (e.g., capable of performing the same function). The cluster control unit 602 receives an instruction sequence, where the instruction sequence includes a data loading instruction. The cluster control unit 602 controls each PE unit to execute the same instruction sequence, and may load different operation data from different data addresses when controlling a data loading instruction in an instruction sequence by using a control signal generated by the cluster control unit 602, for different PE units to obtain different intermediate results based on different operation data.

A PE controller 501 is included in each PE unit. Each PE unit further includes a data loading unit 502, a weight queue 503, an input buffer 504, an index comparison unit 505, a multiplier 512, a selector 511, an accumulative buffer 506, a buffer 508, an output queue 513, selectors 516, 512, and 514, a special control unit 509, and a special functional unit 510.

The data loading unit 502 is configured to: load input data, and store the input data into the weight queue 503 or the input buffer 504 according to a data type of the input data. The data type of the input data includes weight data and activation data, the weight data is stored in the weight queue 503, and the activation data is stored in the input buffer 504. In addition, the data loading unit 502 generates a bit mask of the activation data by checking whether each value of the activation data (that is, checking each item of a matrix) is equal to 0, that is, the bit mask of the activation data is used to indicate whether each value of the activation data is 0.

In some embodiments, when compiling and deploying a neural network model, the processing unit 220 organizes and stores weight data in the neural network model in a form of “non-zero value+weight index”. Therefore, when the weight data enters a PE cluster by using a distribution unit 601, the weight data loaded into a weight queue 503 is a weight index and a non-zero value corresponding to the weight index (in the weight queue 503 in the figure, the weight index and the non-zero value corresponding to the weight index are marked with different patterns). In some other embodiments, before the weight data enters the weight queue 503, the distribution unit 601 and the command processor 238 complete organizing and storing the weight data in the form of “non-zero value+weight index”. These two implementations are particularly applicable to a sparse neural network model.

As shown in the figure, in order to implement streaming storage of the weight data, the weight queue 503 is designed using a queue-like architecture. A storage unit constituting the weight queue 503 may be a shift register, and may form a loopback path to support multiplexing of the weight data during a convolution operation. The loopback path refers to a head-to-tail connected queue. When a write and/or read operation reaches the tail of the queue, a next write and/or read operation returns to the head of the queue.

The input buffer 504 stores the activation data and the bit mask generated according to the activation data. Although not shown, each value of the activation data is also represented as an activation index and an activation value corresponding to the activation index. Thus, the input buffer 504 stores the activation index, the activation value corresponding to the activation index, and a bit mask corresponding to the activation index.

The index comparison unit 505 is responsible for generating a payload, where the payload is a matrix operation based on a non-zero weight and the activation data. The index comparison unit 505 includes a summator and a comparator. The summator is configured to add the weight index and a base address (the weight index is received from the weight queue 503, and the base address is obtained from the cluster control unit 602) to obtain an input index. The comparator receives the input index of the summator, compares the input index with an index value output by the output buffer 504, and generates and provides a control signal to a control end of the selector 511 if the input index is the same as the index value and a corresponding value indicated by the bit mask is not 0, for the input buffer 504 to output a value corresponding to the input index and provide the value to the multiplication accumulator 506. The multiplication accumulator 506 is configured to perform a multiplication accumulation operation. The multiplication accumulator 506 stops the accumulation operation of the multiplication accumulator according to a control signal of the PE controller 501, and outputs an accumulation result to the buffer.

In the accumulative buffer 506, a product generated by the multiplier 512 is accumulated by the summator 5061. The accumulation result is input to the selector 5062 to decide to store the accumulation result into one of four buffers 5063 according to the control signal from the PE controller 501, depending on the operation. Each PE unit is equipped with four homogeneous accumulative buffers 5063. The accumulation result stored in the accumulative buffer 5063 is transmitted to different submodules, depending on the operation. As shown in the figure, by using the selectors 5063 and 5064, the accumulation result may be transmitted to the summator 5061 to continue the accumulation operation, and the accumulation result is also stored into the output queue 513 by using the buffer 508 and selectors 515 and 516. The output queue 513 may store accumulation results of a plurality of operations, and these intermediate results may be transferred to a storage unit by using the distribution unit 601, and may further be transferred to an external memory. The accumulation result may also be stored in the output queue 513 as an intermediate result for a long time and provided to the four buffers 5063 in due time to summate a plurality of accumulation results again. The accumulation result may also be provided to the special functional unit 510 by using the selector 516. The accumulation result in the output queue 513 may alternatively be provided to the special functional unit 510 by using the selector 514.

The special functional unit (SFU) 510 is configured to perform all special functions required by the neural network model. The special functional unit (SFU) 510 may be coupled to a plurality of parallel PE units by using a message queue/FIFO interface. The special functional unit 510 has its own instruction path and operates asynchronously with all parallel PEs. Therefore, the special functional unit 510 uses only a small quantity of hardware operation operators to match throughputs of a plurality of PE units while minimizing an area and power consumption. According to a specific application scenario, the special functional unit 510 may operate in two modes: a chain mode and a decoupling mode. The chain mode is usually applied to an element-wise special function, such as an activation function of a neural network model. Usually, the data in the accumulative buffer 506 is written into the output queue 513, and then the special functional unit 510 reads the output queue 513 to execute the special function and writes a final result back into the output queue 513.In the chain mode, the data in the accumulative buffer 506 is transferred directly to the special functional unit 510 instead of the output queue 513. In this way, the special functional unit 510 only needs a local output buffer address corresponding to each PE unit, and memory access to the output buffer 513 is reduced by ⅔. The decoupling mode is usually applied to some special functions, such as reduction, which require data on parallel PE units (input data is staggered among all PE units). When these special functions are executed, the data in the queue in the special functional unit 510 identifies, by using a mark/token, a PE to which the data belongs. By using the mark/token, the special functional unit 510 may effectively determine whether a current special function has been completed. Different from the chain mode, the decoupling mode requires a global output buffer address to flexibly access output data of any PE unit.

Mapping a Neural Network Application to an Acceleration Unit in an Embodiment of the Present Disclosure for Execution

The acceleration unit may support a plurality of neural network applications, and commonly used neural network applications include: matrix multiplication, convolution, and depth convolution. The most basic operations of these neural network applications are multiplication and accumulation operations. Therefore, the PE unit designed in the disclosed embodiments mainly completes multiplication and accumulation operations. The following provides detailed description based on a neural network application.

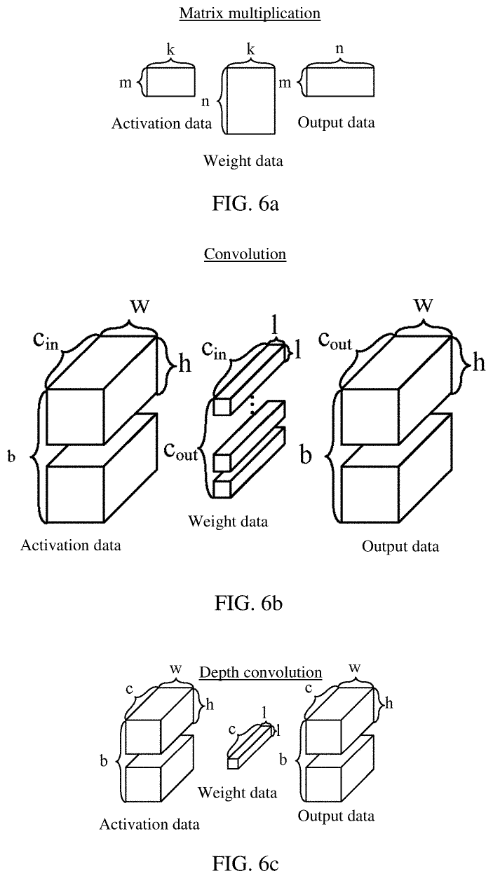

FIG. 6a is a schematic diagram of matrix multiplication. As shown in FIG. 6a, activation data is a two-dimensional matrix of m*k, m represents a row, k represents a column, weight data is a matrix of k*n, k represents a row, n represents a column, output data is a matrix of m*n, m represents a row, and n represents a column. For example, A is a matrix of 2*3, B is a matrix of 3*2, and C is a matrix product of A and B and is a matrix of 2*2. An operation process of C is as follows:

$$A = [ \begin{matrix}a 11 & a 12 & a 13 \\ a 21 & a 22 & a 23\end{matrix} ] \qquad Formula ( 1 )$$

$$B = [ \begin{matrix}b 11 & b 12 \\ b 21 & b 22 \\ b 31 & b 32\end{matrix} ] \qquad Formula ( 2 )$$

$$\begin{matrix}C = AB \\ = [ \begin{matrix}a 11 b 11 + a 12 b 21 + a 13 b 31 & a 11 b 12 + a 12 b 22 + a 13 b 32 \\ a 21 b 11 + a 22 b 21 + a 23 b 31 & a 21 b 12 + a 22 b 22 + a 23 b 32\end{matrix} ]\end{matrix} \qquad Formula ( 3 )$$

As shown in FIG. 6b and FIG. 6c, more dimensions are included in convolution and depth convolution. Referring to FIG. 6b, the activation data, the weight data, and the output data are all four-dimensional matrices (in this specification, one-dimensional and two-dimensional matrices are referred to as low-dimensional matrices, and three-dimensional and higher-dimensional matrices are referred to as high-dimensional matrices). Parameters of the activation data are [b, w, h, cin], parameters of the weight data are [cout, 1, 1, cin], and parameters of the output data are [b, w, h, cout]. For convenience of understanding, this example is understood as a convolution operation on image data. b represents a quantity of images, w and h represent a width and a height in an image size, and cin represents a quantity of channels, for example, cin of an RGB image is equal to 3. The convolution operation may be understood as a process in which a convolution core of 1*1*cin is used to scan each image (a cube defined by cin, w, and h in the figure) to obtain an output image. A corresponding calculation process of the convolution operation is: first calculating an inner product of a matrix of 1*1 and a corresponding feature element in a two-dimensional image, summing values of inner products, and then adding a sum of inner products of cin corresponding coordinates as values of corresponding coordinates in a two-dimensional feature map. In other words, the convolution core of 1*1*cin and an image defined by [w, h, and cin] are calculated to obtain a two-dimensional feature map of w*h. cout convolution cores of 1*1*cin and an image defined by [w, h, cin] are calculated to obtain an output feature map of cout*w*h. Because there are b images that are used as activation data, b output feature maps of cout*w*h are finally obtained. A calculation process of depth convolution in FIG. 6c includes: first calculating an inner product of a convolution core of 1*1 and a corresponding feature element in an input two-dimensional image, and using a sum of values of inner products as a value of a corresponding coordinate on an output two-dimensional feature diagram, where c is a quantity of channels of the input and the convolution core, and remains unchanged as a quantity of channels of the output image, to finally obtain b feature maps of c*w*h.

It may be found from the foregoing content that a base of convolution and depth convolution is a matrix operation (multiplication and accumulation), but convolution and depth convolution involve more dimensions. However, during program processing, high-dimensional matrix operations of convolution and depth convolution may be converted into a plurality of low-dimensional matrix operations of a plurality of iterations. FIG. 6a to FIG. 6c are used as an example. bwh in FIG. 6b and FIG. 6c corresponds to m, cin corresponds to k in FIG. 6a, and cout corresponds to n in FIG. 6a. In this manner, convolution and depth convolution indicated in FIG. 6b to FIG. 6c are converted into matrix operations of a two-dimensional matrix m*k and k*n of a plurality of iterations. When a neural network application is performed, an operation of loading data required for each operation into the on-chip memory 236 by using a direct memory access (DMA) module 235 is further involved.

During implementation, there are a plurality of implementations of converting high-dimensional matrix operations of convolution and depth convolution into a plurality of low-dimensional matrix operations of a plurality of iterations. In this embodiment, three mapping methods are defined: an input stationary mapping method, a weight stationary mapping method, and an output stationary mapping method. When processing the neural network application, the command processor 238 may select one of the mapping methods. For each neural network application, a preferred mapping manner should reduce data transmission between the acceleration unit 2301 and the external memory 210. Therefore, the acceleration unit 2301 may configure a preferred mapping method for each neural network application, so that a corresponding method is used when each neural network application is executed.

The following uses matrix multiplication as an example to describe the three mapping methods.

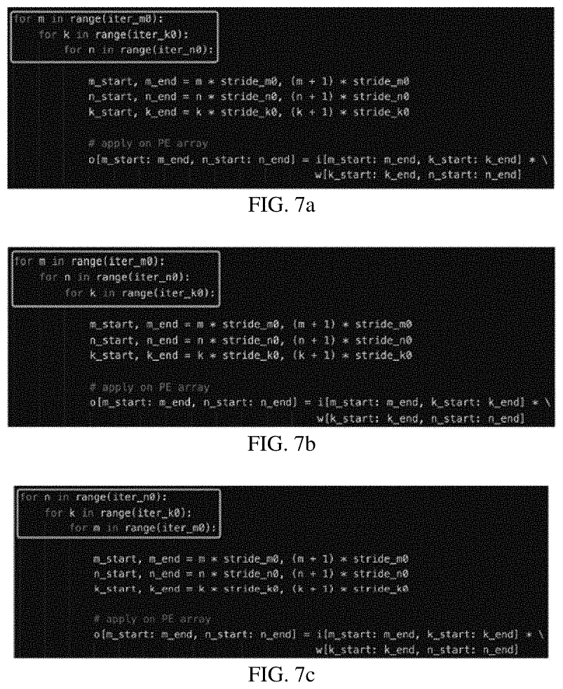

A core idea of the input stationary mapping method is to keep activation data in a PE array as long as possible. The following describes a pseudo code example shown in FIG. 7a. The segment of pseudo code includes a plurality of iterations (a quantity of iterations is determined by iter_n0, iter_k0, and iter_m0), and each iteration specifies one two-dimensional matrix multiplication that runs on the PE array. Symbols of an input matrix of the two-dimensional matrix multiplication are i (activation data) and w (weight data), and a symbol of an output matrix is o. For i, a row start sequence number and a row end sequence number of i in a two-dimensional matrix (converted from activation data of a high-dimensional matrix) are defined by using m_start and m_end, and a column start sequence number and a column end sequence number of i in the two-dimensional matrix are defined by using k_start and k_end. Similarly, for w, a row start sequence number and a row end sequence number of w in a two-dimensional matrix (converted from weight data of the high-dimensional matrix) are defined by using k_start and k_end, and a column start sequence number and a column end sequence number of w in the two-dimensional matrix are defined by using n_start and n_end. For o, the same holds true.

It can be learned from the pseudo code that, as a conditional statement of a nested loop, n changes before k and k changes before m, and a two-dimensional matrix from the weight data and defined by k*n changes before a two-dimensional matrix from the activation data and defined by m*k. Therefore, when m and k remain unchanged and n changes, a two-dimensional matrix defined by m*k is deployed on the PE array for a period of time, and a two-dimensional matrix defined by k*n is continuously loaded from the external memory and transported into the PE array. When k changes, the two-dimensional matrix defined by m*k changes. In this case, new m*k is loaded from the external memory into the PE array. With this design, the activation data (m*k) stays in the PE array longer than the weight data (k*n). In addition, the output two-dimensional matrix defined by m*n sometimes needs to be written back into the memory 210. It should be noted that if the PE array can maintain all two-dimensional matrices defined by m*k, it is not necessary to use the input stationary mapping method.

A core idea of the output stationary mapping method is to keep output data in the on-chip memory 236 as long as possible. Corresponding pseudo code is shown in FIG. 7b. For analysis of this segment of pseudo code, refer to the foregoing description. It should be noted that when all the activation data can be stored in the on-chip memory 236, it is not necessary to use an input stationary data loading method.

A core idea of the weight stationary mapping method is to keep the weight data in the on-chip memory 236 as long as possible (longer than the activation data). Corresponding pseudo code is shown in FIG. 7c. For analysis of this segment of pseudo code, refer to the foregoing description. It should be noted that the weight stationary mapping method can only be used when the weight data is separated from calculation. If the weight data and calculation overlap together, the weight stationary mapping method cannot be used. When the weight stationary mapping method is used, before the command processor 238 loads new activation data into the on-chip memory 236, a portion of current result data (obtained by means of calculation by using the PE array) needs to be written back into the memory 210.

When the foregoing mapping method is performed, a problem of a data transfer pipeline needs to be further considered. Referring to the pseudo code in FIG. 7a, when the PE array performs (k+1)th iteration calculation, the PE array first loads activation data and weight data of this iteration from the on-chip memory 236. The activation data and the weight data in this iteration are loaded from the memory 210 into the on-chip memory 236 by the command processor 238 in a kth iteration. Note that the on-chip memory 236 is used as a global storage area, and each storage unit is designed as two ping-pong buffer. The two ping-pong buffer units may be implemented with two different storage chips, or two different memory sections within the storage unit. A first unit is configured to load data from the memory 210, a second unit is configured to provide data for the PE array, and the first unit and the second unit switch roles after each iteration of processing in the PE array. For instance, if the data for a first iteration of execution is loaded and stored in the first unit, the first unit will be used to feed data into the PE array, and at the same time, the second unit may load the data for the next iteration. After the first iteration is finished, the second unit may have loaded the required data, and may be used to feed the required data into the PE array. At the same time, the first unit may load the data for the next (e.g., third) iteration. Thus, during PE calculation, activation and weight data of a next iteration are transmitted from the memory 210 to the on-chip memory 236, and the activation and the weight data of the next iteration are transmitted from the on-chip memory 236 to the PE array. Therefore, if calculation time of the PE array is greater than time for loading the activation and weight data from the memory 210, time for loading the activation and weight data from the memory 210 is hidden within the calculation time of the PE array, which will help improve execution efficiency of the acceleration unit. In the last iteration, input activation data and weight data need to be prepared for the first iteration in a next group. In addition, the output data will be written back into the memory 210 from the PE array in the last iteration. The operation of writing the output data back into the memory 210 from the on-chip memory 236 is performed in the first iteration of the next group.

Data Segmentation Method Performed in an Acceleration Unit in an Embodiment of the Present Disclosure

Referring to the foregoing description, the command processor 238 loads, by using the direct memory access module 235, data required for each iteration into each storage unit of the on-chip memory 236, and then distributes the data to the PE cluster by using the distribution unit, and the PE cluster further distributes the data to the PE unit. In this process, the distribution unit generally segments the matrix according to dimensions m, n, and k to obtain a matrix that can be distributed to the PE cluster.

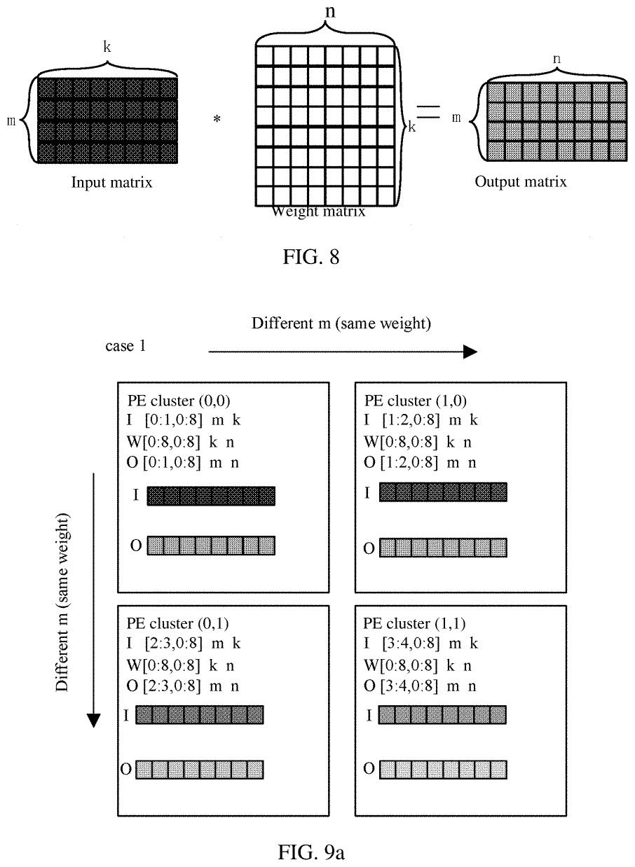

Referring to FIG. 8, activation data is a two-dimensional matrix in which a quantity of rows is 4 and a quantity of columns is 8; weight data is a two-dimensional matrix in which a quantity of rows is 8 and a quantity of columns is 8; and an output matrix is a two-dimensional matrix in which a quantity of rows is 4 and a quantity of columns is 8. The following describes how to deploy matrix multiplication shown in FIG. 8 to a PE array of 2*2 for execution, where the PE array of 2*2 includes a PE cluster (0, 0), a PE cluster (1, 0), a PE cluster (0, 1), and a PE cluster (1, 1). In our design, each PE cluster is a two-dimensional grid. Therefore, when the foregoing matrix is mapped to the PE array, there are three choices in each dimension, and there are nine choices in total.

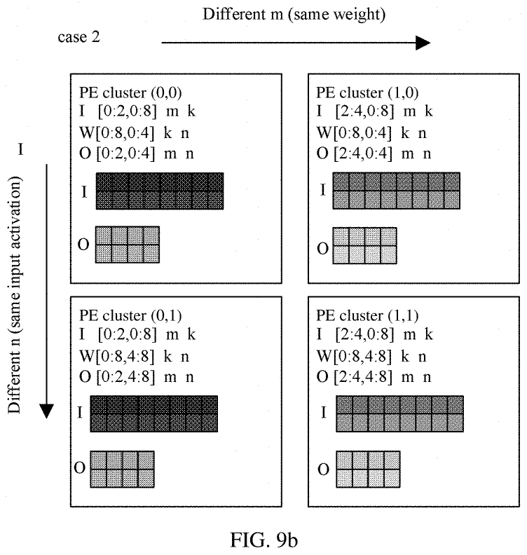

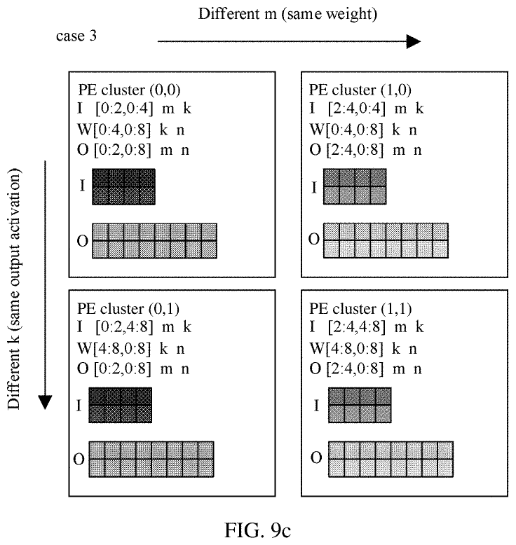

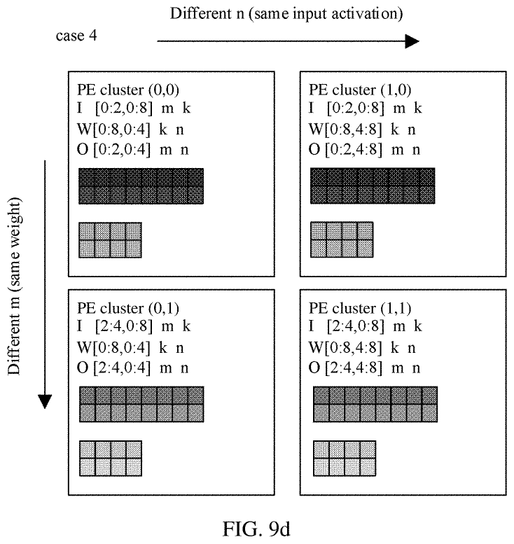

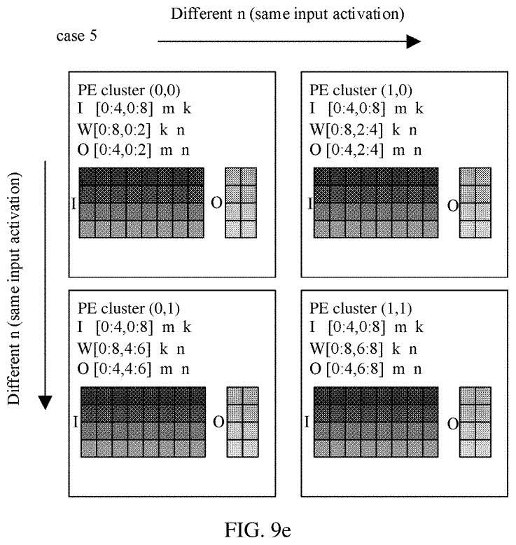

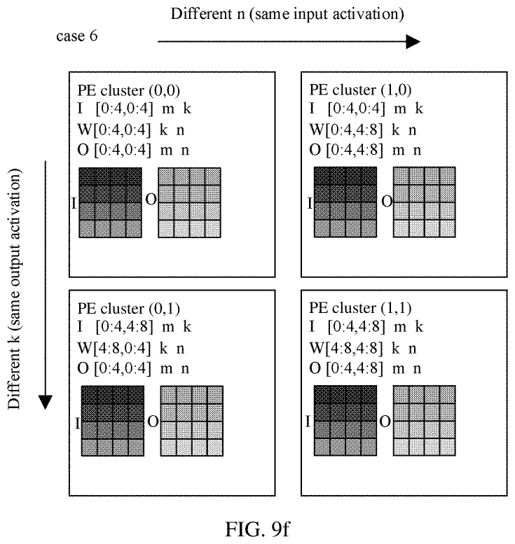

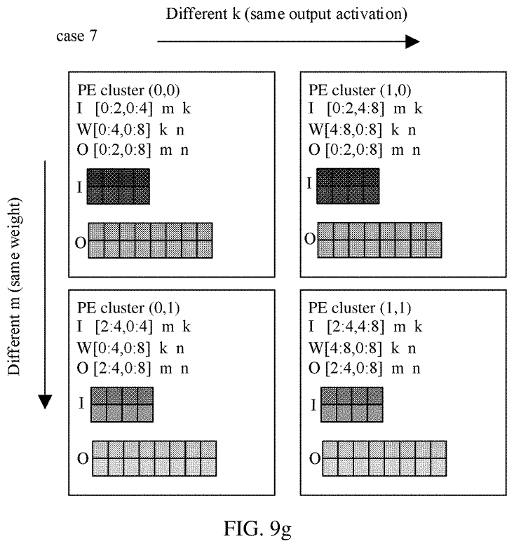

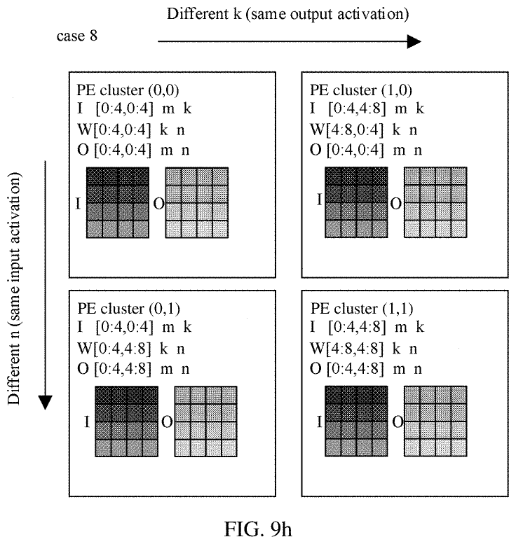

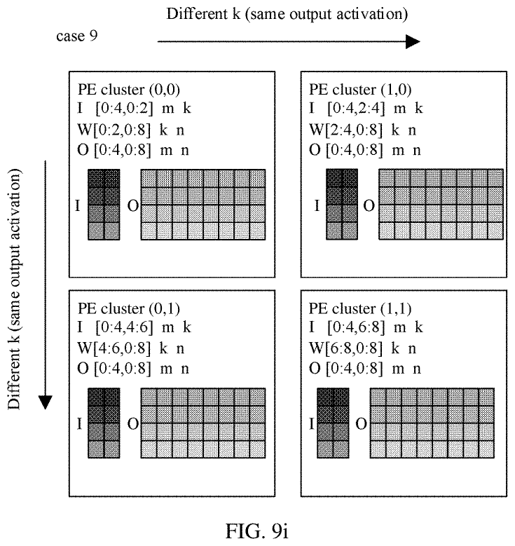

FIG. 9a to FIG. 9i illustrate nine choices for deploying the matrix multiplication shown in FIG. 8 to a PE array. In the figure, I, W, and O represent activation data, weight data, and an output matrix of the matrix multiplication performed in the corresponding PE cluster, respectively.

In FIG. 9a, the PE cluster (0, 0) executes a task of multiplying the first row (that is, I[0:1, 0:8]) of the activation data by the weight data (that is, W[0:8, 0:8]), and an execution result is to output the first row (that is, O [0:1, 0:8]) of output data. [0:1, 0:8] in I[0:1, 0:8] specifies rows and columns of input data, [0, 1] represents the first row, [0, 8] represents the first column to the eighth column, W[0:8, 0:8] represents a matrix formed by the first row to the eight row and the first column to the eighth column in the weight data, that is, complete weight data, and O [0:1, 0:8] represents a matrix formed by the first row and the first column to the eighth column in the output data. Data in FIG. 9a to FIG. 9i are represented in the same manner, and therefore details are not provided below. The PE cluster (1, 0) executes a task of multiplying the second row (that is, I[1:2,0:8]) of the activation data by the weight data (that is, W[0:8, 0:8]), and an execution result is to output the second row (that is, O[1:2,0:8]) of an output matrix. The PE cluster (0, 1) executes a task of multiplying the third row (that is, I[2:3,0:8]) of the activation data by the weight data (that is, W[0:8, 0:8]), and an execution result is to output the third row (that is, [2:3,0:8]) of the output matrix. The PE cluster (1, 1) executes a task of multiplying the fourth row (that is, I[3:4,0:8]) of the activation data by the weight data (that is, W[0:8, 0:8]), and an execution result is to output the fourth row (that is, O [2:3,0:8]) of the output matrix.

It may be learned from FIG. 9a that input and output matrices that participate in matrix multiplication in the PE cluster (0, 0) to the PE cluster (1, 1) are different, but the weight data that participates in matrix multiplication in the PE cluster (0, 0) to the PE cluster (1, 1) is the same, that is, the weight data is shared among the PE cluster (0, 0) to the PE cluster (1, 1).

In FIG. 9b, the PE cluster (0, 0) executes a task of multiplying the first two rows (I[0:2, 0:8]) of the activation data by the first four columns (that is, W[0:8, 0:4]) of the weight data, and an execution result is to output the first two rows and the first four columns (that is, O[0:2, 0:4]) of the output data. The PE cluster (1, 0) executes a task of multiplying the last two rows (that is, I[2:4,0:8]) of the activation data by the last four columns (that is, W[0:8, 0:4]) of the weight data, and an execution result is to output the first two rows and the first four columns (that is, O[0:2,0:4]) of the output matrix. The PE cluster (0, 1) executes a task of multiplying the first two rows (that is, I[0:2,0:8]) of the activation data by the last four columns (that is, W[0:8, 4:8]) of the weight data, and an execution result is to output the first two rows and the last four columns (that is, [0:2,4:8]) of the output matrix. The PE cluster (1, 1) executes a task of multiplying the first two rows (that is, I[2:4,0:8]) of the activation data by the last four columns (that is, W[0:8,4:8]) of the weight data, and an execution result is to output the first two rows and the last four columns (that is, O [2:4,4:8]) of the output matrix.

It may be learned from FIG. 9b that input and output matrices that participate in matrix multiplication in the PE cluster (0, 0) to the PE cluster (1, 1) are different, but the weight data in the PE cluster (0, 0) and the PE cluster (1, 0) is the same, and the weight data in the PE cluster (0, 1) and the PE cluster (1, 1) is the same.

In FIG. 9c, the PE cluster (0, 0) executes a task of multiplying the first two rows and the first four columns (I[0:2,0:4]) of the activation data by the first four rows (that is, W[0:4,0:8]) of the weight data, and an execution result is to output the first two rows (that is, O[0:2,0:8]) of the output data. The PE cluster (1, 0) executes a task of multiplying the last two rows and the first four columns (that is, I[2:4,0:4]) of the activation data by the first four rows (that is, W[0:4,0:8]) of the weight data, and an execution result is to output the last two rows (that is, O[2:4,0:8]) of the output matrix. The PE cluster (0, 1) executes a task of multiplying the first two rows and the last four columns (I[0:2,4:8]) of the activation data by the last four rows (that is, W[4:8,0:8]) of the weight data, and an execution result is to output the first two rows (that is, [0:2,0:8]) of the output matrix. The PE cluster (1, 1) executes a task of multiplying the first two rows and the last four columns (that is, I[2:4,4:8]) of the activation data by the last four rows (that is, W[4:8,0:8]) of the weight data, and an execution result is to output the first two rows (that is, O [2:4,0:8]) of the output matrix.

It may be learned from FIG. 9c that matrices output from the PE cluster (0, 0) and the PE cluster (0, 1) are the same, and values at positions corresponding to the two matrices need to be added to obtain a final value. Similarly, matrices output from the PE cluster (1, 0) and the PE cluster (1, 1) are the same, and values at positions corresponding to the two matrices need to be added to obtain a final value.

In FIG. 9d, the PE cluster (0, 0) executes a task of multiplying the first two rows (I[0:2, 0:8]) of the activation data by the first four columns (that is, W[0:8, 0:4]) of the weight data, and an execution result is to output the first two rows and the first four columns (that is, O[0:2, 0:4]) of the output data. The PE cluster (1, 0) executes a task of multiplying the first two rows (that is, I[0:2,0:8]) of the activation data by the last four columns (that is, W[0:8, 4:8]) of the weight data, and an execution result is to output the first two rows and the last four columns (that is, O[0:2,4:8]) of the output matrix. The PE cluster (0, 1) executes a task of multiplying the last two rows (I[2:4,0:8]) of the activation data by the first four columns (that is, W[0:8, 0:4]) of the weight data, and an execution result is to output the last two rows and the first four columns (that is, [2:4,0:4]) of the output matrix. The PE cluster (1, 1) executes a task of multiplying the last two rows (that is, I[2:4,0:8]) of the activation data by the last four columns (that is, W[0:8,4:8]) of the weight data, and an execution result is to output the last two rows and the last four columns (that is, O [2:4,4:8]) of the output matrix.

Based on FIG. 9d, output matrices on the PE cluster (0, 0) to the PE cluster (1, 1) are combined to obtain a final matrix multiplication result.

In FIG. 9e, the PE cluster (0, 0) executes a task of multiplying the activation data (I[0:4,0:8]) by the first two columns (that is, W[0:8,0:2]) of the weight data, and an execution result is to output the first two columns (that is, O[0:4, 0:2]) of the output data. The PE cluster (1, 0) executes a task of multiplying the activation data (that is, I[0:4,0:8]) by the third column and the fourth column (that is, W[0:8,2:4]) of the weight data, and an execution result is to output the third column and the fourth column (that is, O[0:4,2:4]) of the output matrix. The PE cluster (0, 1) executes a task of multiplying the activation data (I[0:4,0:8]) by the fifth column and the sixth column (that is, W[0:8,4:6]) of the weight data, and an execution result is to output the fifth column and the sixth column (that is, [0:4,4:6]) of the output matrix. The PE cluster (1, 1) executes a task of multiplying the activation data (that is, I[0:4,0:8]) by the seventh column and the eighth column (that is, W[0:8,6:8]) of the weight data, and an execution result is to output the seventh column and the eighth column (that is, O [0:4,6:8]) of the output matrix.

Based on FIG. 9e, output matrices on the PE cluster (0, 0) to the PE cluster (1, 1) are combined to obtain a final matrix multiplication result.

In FIG. 9f, the PE cluster (0, 0) executes a task of multiplying the first four columns (I[0:4,0:4]) of the activation data by the first four rows and the first four columns (that is, W[0:4,0:4]) of the weight data, and an execution result is to output the first four columns (that is, O[0:4,0:4) of the output data. The PE cluster (1, 0) executes a task of multiplying the first four columns (that is, I[0:4,0:4]) of the activation data by the first four rows and the last four columns (that is, W[0:4,4:8]) of the weight data, and an execution result is to output the first four rows and the last four columns (that is, O[0:4,4:8]) of the output matrix. The PE cluster (0, 1) executes a task of multiplying the last four columns (I[0:4,4:8]) of the activation data by the last four rows and the first four columns (that is, W[4:8,4:4]) of the weight data, and an execution result is to output the first four rows and the first four columns (that is, [0:4,0:4]) of the output matrix. The PE cluster (1, 1) executes a task of multiplying the last four columns (that is, I[0:4,4:8]) of the activation data by the last four rows and the last four columns (that is, W[4:8,4:8]) of the weight data, and an execution result is to output the last four columns (that is, O[0:4,4:8]) of the output matrix.

Based on FIG. 9f, corresponding values of the output matrices on the PE cluster (0, 0) and the PE cluster (0, 1) are added to obtain a final value, corresponding values of the output matrices on the PE cluster (1, 0) and the PE cluster (1, 1) are added to obtain a final value, and a finally combined matrix is a final matrix multiplication result.

In FIG. 9g, the PE cluster (0, 0) executes a task of multiplying the first two rows and the first four columns (I[0:2,0:4]) of the activation data by the first four rows (that is, W[0:4,0:8]) of the weight data, and an execution result is to output the first two rows (that is, O[0:2,0:8]) of the output data. The PE cluster (1, 0) executes a task of multiplying the first two rows and the last four columns (that is, I[0:2,4:8]) of the activation data by the last four rows (that is, W[4:8,0:8]) of the weight data, and an execution result is to output the first two rows (that is, O[0:2,0:8]) of the output matrix. The PE cluster (0, 1) executes a task of multiplying the third row and the fourth row and the first four columns (that is, I[2:4,0:4]) of the activation data by the first four columns (that is, W[0:4,0:8]) of the weight data, and an execution result is to output the third row and the fourth row (that is, [2:4,0:8]) of the output matrix. The PE cluster (1, 1) executes a task of multiplying the last two rows and the last four columns (that is, I[2:4,4:8]) of the activation data by the last four rows (that is, W[4:8,0:8]) of the weight data, and an execution result is to output the last two rows (that is, O[2:4,0:8]) of the output matrix.

Based on FIG. 9g, corresponding values of the output matrices on the PE cluster (0, 0) and the PE cluster (1, 0) are added to obtain a final value, corresponding values of the output matrices on the PE cluster (0, 1) and the PE cluster (1, 1) are added to obtain a final value, and a finally combined matrix is a final matrix multiplication result.

In FIG. 9g, the PE cluster (0, 0) executes a task of multiplying the first two rows and the first four columns (I[0:2,0:4]) of the activation data by the first four rows (that is, W[0:4,0:8]) of the weight data, and an execution result is to output the first two rows (that is, O[0:2,0:8) of the output data. The PE cluster (1, 0) executes a task of multiplying the first two rows and the last four columns (that is, I[0:2,4:8]) of the activation data by the last four rows (that is, W[4:8,0:8]) of the weight data, and an execution result is to output the first two rows (that is, O[0:2,0:8]) of the output matrix. The PE cluster (0, 1) executes a task of multiplying the third row and the fourth row and the first four columns (that is, I[2:4,0:4]) of the activation data by the first four columns (that is, W[0:4,0:8]) of the weight data, and an execution result is to output the third row and the fourth row (that is, [2:4,0:8]) of the output matrix. The PE cluster (1, 1) executes a task of multiplying the last two rows and the last four columns (that is, I[2:4,4:8]) of the activation data by the last four rows (that is, W[4:8,0:8]) of the weight data, and an execution result is to output the last two rows (that is, O[2:4,0:8]) of the output matrix.

Based on FIG. 9g, corresponding values of the output matrices on the PE cluster (0, 0) and the PE cluster (1, 0) are added to obtain a final value, corresponding values of the output matrices on the PE cluster (0, 1) and the PE cluster (1, 1) are added to obtain a final value, and a finally combined matrix is a final matrix multiplication result.

In FIG. 9h, the PE cluster (0, 0) executes a task of multiplying the first four columns (I[0:4,0:4]) of the activation data by the first four rows and the first four columns (that is, W[0:4,0:4]) of the weight data, and an execution result is to output the first four columns (that is, O[0:4,0:4) of the output data. The PE cluster (1, 0) executes a task of multiplying the last four columns (that is, I[0:4,4:8]) of the activation data by the last four rows (that is, W[4:8,0:8]) of the weight data, and an execution result is to output the first four columns (that is, O[0:4,0:4]) of the output matrix. The PE cluster (0, 1) executes a task of multiplying the first four columns (I[0:4,0:4]) of the activation data by the first four rows and the last four columns (that is, W[0:4,4:8]) of the weight data, and an execution result is to output the first four rows and the last four columns (that is, [0:4,4:8]) of the output matrix. The PE cluster (1, 1) executes a task of multiplying the last four columns (that is, I[0:4,4:8]) of the activation data by the last four rows and the last four columns (that is, W[4:8,4:8]) of the weight data, and an execution result is to output the last four columns (that is, O[0:4,4:8]) of the output matrix.

Based on FIG. 9h, corresponding values of the output matrices on the PE cluster (0, 0) and the PE cluster (1, 0) are added to obtain a final value, corresponding values of the output matrices on the PE cluster (0, 1) and the PE cluster (1, 1) are added to obtain a final value, and a finally combined matrix is a final matrix multiplication result.

In FIG. 9i, the PE cluster (0, 0) executes a task of multiplying the first two columns (I[0:4,0:2]) of the activation data by the first two rows (that is, W[0:2,0:8]) of the weight data, and an execution result is to output the output data (that is, O[0:4,0:8). The PE cluster (1, 0) executes a task of multiplying the third column and the fourth column (that is, I[0:4,2:4]) of the activation data by the third row and the fourth row (that is, W[2:4,0:8]) of the weight data, and an execution result is to output the first four rows (that is, O[0:4,0:8]) of the output matrix. The PE cluster (0, 1) executes a task of multiplying the fifth column and the sixth column (I[0:4,4:6]) of the activation data by the fifth row and the sixth row (that is, W[4:6,0:8]) of the weight data, and an execution result is to output the output matrix (that is, [0:4,0:8]). The PE cluster (1, 1) executes a task of multiplying the last two columns (that is, I[0:4,6:8]) of the activation data by the seventh row and the eighth row (that is, W[6:8,0:8]) of the weight data, and an execution result is to output the output matrix (that is, O[0:4,0:8]).

Based on FIG. 9i, corresponding values of the output matrices on the PE cluster (0, 0) to the PE cluster (1, 1) are added to obtain a final matrix multiplication result.

In summary, segmentation along an m direction (row direction of the activation data) means that different PE clusters process the activation data and different row data of the output matrix, but these PE clusters share the same weight data. A quantity of PE clusters involved in the calculation may be determined according to an effective quantity of rows of the activation data. For example, in sparse matrix-vector multiplication (SPMV), only one PE cluster is effective (row and column directions of the PE array contain different m).

Segmentation along an n direction (column direction of the weight data) means that different PE clusters calculate various output matrix slices that are segmented in the n direction, and the same input matrix slice is shared between the PE clusters. In this segmentation method, different PE clusters need different weight data. If a degree of multiplexing of the weight data in the calculation is low (smaller m), a data transmission delay will become more severe.

Segmentation along a k direction (row direction of the weight data) means that different PE clusters calculate a partial sum of the same output matrix slice. In this segmentation method, data is not shared between different PE clusters during calculation. In addition, parts generated by different clusters need to be accumulated together to obtain a final result.

According to the acceleration unit provided in the embodiments of the present disclosure, a specific operation of a neural network model is decomposed into a plurality of sub-operations, operation data of each sub-operation is obtained by using a direct memory access module for a plurality of times, and then the sub-operation is deployed on a PE array for execution. Because the PE array includes three-dimensional PE units, parallel execution of the three-dimensional PE units can implement hardware acceleration of the neural network model.

Further, the decomposing a specific operation of a neural network model into a plurality of sub-operations and deploying each sub-operation to a PE array is: converting an operation of activation data and weight data of a high-dimensional matrix into an operation of activation data and weight data of a low-dimensional matrix that is iteratively performed, and deploying the operation of the activation data and the weight data of the low-dimensional matrix to a PE array, where each PE unit may be configured to perform a one-dimensional matrix multiplication operation, and one-dimensional multiplication operation results may be further accumulated together, which helps implement hardware acceleration of a neural network application.

It should be understood that, because the neural network model mainly includes several key operations, such as matrix multiplication, convolution, and depth convolution, these key operations may be converted into an operation of activation data and weight data of a low-dimensional matrix. By performing a low-dimensional matrix operation in parallel by using the PE array, hardware acceleration of the neural network application can be implemented, and further hardware acceleration of the neural network model is implemented.

In addition, although different mapping methods may be used to map each specific operation to an operation of activation data and weight data of a low-dimensional matrix, for an inherent feature of each specific operation, a preferred mapping method can reduce data movement between an external memory and the PE array or the PE unit compared with a remaining mapping method. Therefore, a preferred mapping method is generally set for each specific operation. For example, for matrix multiplication, a preferred mapping method is an input stationary mapping method.

Commercial Value of Embodiments of the Present Disclosure

The acceleration unit provided in the embodiments of the present disclosure performs a matrix operation in parallel by using a PE array, and the matrix operation is a basic operation of a neural network model. Therefore, the acceleration matrix operation can accelerate an execution speed of the neural network model. Currently, many implemented applications are configured with a neural network model, that is, the acceleration unit provided in the embodiments of the present disclosure has a realistic application scenario. Therefore, the acceleration unit provided in the embodiments of the present disclosure has a market prospect and commercial value.

A person skilled in the art can understand that the present disclosure may be implemented as a system, a method, and a computer program product. Therefore, the present disclosure may be, for example, implemented in the following forms: complete hardware, complete software (including firmware, resident software, and microcode), or may be implemented in a form of a combination of software and hardware. In addition, in some embodiments, the present disclosure may further be implemented in a form of a computer program product in one or more computer readable media that include computer readable program code.

Any combination of one or more computer readable media may be used. The computer readable medium may be a computer readable signal medium or a computer readable storage medium. The computer readable storage medium is, for example, but is not limited to, an electrical, magnetic, optical, electromagnetic, infrared, or semiconductor system, apparatus, or device, or any other combination thereof. A more specific example of the computer readable storage medium includes a specific electrical connection of one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical memory, a magnetic memory, or any suitable combination thereof. In this specification, the computer readable storage medium may be any tangible medium that includes or stores a program, and the program may be used by or in combination with a processing unit, an apparatus, or a device.

The computer readable signal medium may be included in a baseband or a data signal propagated as a portion of a clipped wave, and carries computer readable program code. The data signal propagated in such manner may be in a plurality of forms, including but not limited to an electromagnetic signal, an optical signal, or any other suitable combination. The computer readable signal medium may further be any computer readable medium other than a computer readable storage medium, and the computer readable medium may send, propagate, or transmit a program used by or in combination with an instruction system, apparatus, or device.

The program code included in the computer readable medium may be transmitted in any suitable medium, including but not limited to wireless, wire, optical cable, RF, and any suitable combination thereof.

Computer program code for executing the embodiments of the present disclosure may be compiled in one or more programming languages or combinations. The programming languages include an object-oriented programming language, for example, JAVA and C++, and may further include a conventional procedural programming language, for example, C. The program code may be completely executed on a user computer, or may be partially executed on a user computer as a standalone software package, or may be partially executed on a user computer and partially executed on a remote computer, or may be completely executed on a remote computer or a server. In cases involving the remote computer, the remote computer may be connected to a user computer through any type of network, including a local area network (LAN) or a wide area network (WAN), or may be connected to an external computer (for example, via the Internet using an Internet service provider).

The foregoing descriptions are exemplary embodiments of the present disclosure but are not intended to limit the present disclosure. The present disclosure may include various modifications and changes for a person skilled in the art. Any modification, equivalent replacement, or improvement made without departing from the spirit and principle of the present disclosure shall fall within the protection scope of the present disclosure.

What is claimed is:

1. A hardware accelerator for accelerating execution of a neural network model, comprising:
a direct memory access circuit, configured to load operation data of a plurality of sub-operations for a plurality of times;
a plurality of cluster groups, wherein each of the cluster groups comprises a plurality of processing clusters;
an on-chip memory, comprising a plurality of storage units respectively corresponding to the plurality of cluster groups, each of the plurality of storage units being configured to store an instruction sequence and operation data for the corresponding cluster group;
a command processor, configured to decompose an operation associated with a specified neural network model into a plurality of sub-operations, convert the plurality of sub-operations into a plurality of instruction sequences executable on the plurality of processing clusters, and specify operation data for execution of each of the instruction sequences; and
a plurality of distribution circuits, respectively coupled to the plurality of storage units, and respectively coupled to the plurality of cluster groups, wherein each distribution circuit is configured to read the instruction sequence and operation data of the instruction sequence from the storage unit coupled to the distribution circuit, and sends the instruction sequence and the operation data of the instruction sequence to the cluster group coupled to the distribution circuit.

2. The hardware accelerator according to claim 1, wherein each of the distribution circuits is coupled to the plurality of processing clusters in the corresponding cluster group by using a first bus, each distribution circuit sends the instruction sequence and operation data of the instruction sequence to the first bus, and the plurality of processing clusters coupled to the distribution circuit obtains the instruction sequence and the operation data of the instruction sequence from the first bus.

3. The hardware accelerator according to claim 1, wherein the processing cluster comprises a cluster control unit and a plurality of execution units that are coupled to the cluster control unit by using a second bus and that have the same function, the cluster control unit obtains the instruction sequence and controls the plurality of execution units coupled to the cluster control unit to separately execute the instruction sequence, and the plurality of execution units coupled to the cluster control unit load operation data required by the plurality of execution units from the second bus when executing a data loading instruction.

4. The hardware accelerator according to claim 1, wherein the decomposing an operation associated with a specified neural network model into a plurality of sub-operations comprises:
converting a high-dimensional matrix operation of weight data and activation data into a plurality of two-dimensional matrix operations; and
the converting the plurality of sub-operations into a plurality of instruction sequences executable on the processing cluster comprises:
converting the plurality of two-dimensional matrix operations into a plurality of instruction sequences executable on the processing cluster.

5. The hardware accelerator according to claim 4, wherein the converting the high-dimensional matrix operation of weight data and activation data into the plurality of two-dimensional matrix operations comprises:
converting four-dimensional activation data into a two-dimensional activation data by mapping three dimensions of the four-dimensional activation data into one dimension of the two-dimensional activation data; and
converting four-dimensional weight data into a two-dimensional weight data by mapping three dimensions of the four-dimensional weight data into one dimension of the two-dimensional weight data.

6. The hardware accelerator according to claim 4, wherein the converting a high-dimensional matrix operation of weight data and activation data into a plurality of two-dimensional matrix operations further comprises:
when a size of a two-dimensional matrix exceeds a preset standard, dividing the two-dimensional matrix by rows and/or columns into a plurality of sub-matrices, and converting the plurality of two-dimensional matrix operations into matrix operations based on the plurality of sub-matrices.

7. The hardware accelerator according to claim 4, wherein the command processor configures a plurality of mapping methods to convert the high-dimensional matrix operation of the weight data and the activation data into a plurality of two-dimensional matrix operations, wherein the high-dimensional matrix operation comprises operating a plurality of three-or-more-dimension matrices.

8. The hardware accelerator according to claim 7, wherein the command processor configures a preferred mapping method for a specific operation associated with a specified neural network model, for the command processor to use the configured preferred mapping method for the specific operation.

9. The hardware accelerator according to claim 8, wherein the specific operation associated with the specified neural network model is one of matrix multiplication, convolution, and depth convolution.

10. The hardware accelerator according to claim 8, wherein the preferred mapping method comprises keeping activation data in the processing cluster longer than weight data during the plurality of two-dimensional matrix operations.

11. The hardware accelerator according to claim 8, wherein the preferred mapping method comprises keeping weight data in the processing cluster longer than activation data during the plurality of two-dimensional matrix operations.

12. The hardware accelerator according to claim 1, wherein the command processor is further configured to:
receive indication information, and
determine according to the indication information, the operation associated with the specified neural network model and a storage location of operation data of the operation.

13. The hardware accelerator according to claim 1, wherein the distribution circuit is further configured to:
store intermediate result data of a processing cluster coupled to the distribution circuit into a corresponding storage unit, and
store the intermediate result data into an external memory by using the direct memory access circuit.

14. The hardware accelerator according to claim 4, wherein the weight data is represented as a combination of an index and a non-zero value.

15. The hardware accelerator according to claim 13, wherein before the execution unit loads the weight data, the command processor or the distribution circuit converts the weight data into the combination of an index and a non-zero value.

16. The hardware accelerator according to claim 1, wherein the command processor is further configured to:
convert a special function in the specified neural network model into a special instruction that is executable on the execution unit.

17. A server, comprising:
an accelerator, comprising:
a direct memory access circuit, configured to load operation data of a plurality of sub-operations for a plurality of times;
a plurality of cluster groups, wherein each of the cluster groups comprises a plurality of processing clusters;
an on-chip memory, comprising a plurality of storage units that are respectively corresponding to the plurality of cluster groups, and each of the plurality of storage units is configured to store an instruction sequence and operation data for the corresponding cluster group;
a command processor, configured to decompose an operation associated with a specified neural network model into a plurality of sub-operations, convert the plurality of sub-operations into a plurality of instruction sequences executable on the plurality of processing clusters, and specify operation data for execution of each of the instruction sequences; and
a plurality of distribution circuits, respectively coupled to the plurality of storage units, and respectively coupled to the plurality of cluster groups, wherein each distribution circuit is configured to read the instruction sequence and operation data of the instruction sequence from the storage unit coupled to the distribution circuit, and sends the instruction sequence and the operation data of the instruction sequence to the cluster group coupled to the distribution circuit;
a scheduler, configured to instruct the accelerator to perform an operation associated with a specified neural network model; and
a memory, configured to store weight data and activation data of the specified neural network application.

18. The server of claim 17, wherein each of the plurality of storage unit comprises a first buffer unit and a second buffer unit, the first buffer unit is configured to load data from an external memory while the second buffer unit is configured to feed data stored therein into the corresponding cluster group.

19. The server of claim 18, wherein the first buffer unit and the second buffer unit switch roles after each iteration of processing in the corresponding cluster group.

20. The server of claim 17, wherein the decomposing an operation associated with a specified neural network model into a plurality of sub-operations comprises:
converting a high-dimensional matrix operation of weight data and activation data into a plurality of two-dimensional matrix operations; and
the converting the plurality of sub-operations into a plurality of instruction sequences executable on the processing cluster comprises:
converting the plurality of two-dimensional matrix operations into a plurality of instruction sequences executable on the processing cluster.
